(19) United States
(12) Patent Application Publication
(10) Pub. No.: US 2006/0127433 A1
(43) Pub. Date: Jun. 15, 2006

(54) Wood-plastic composites

(76) Inventors: Yossef Gohary, Meitar (IL); Haim Stollar, Omer (IL); Michal Levinger, Nofit (IL); Dikla Dvora, Beer Sheva (IL)

Correspondence Address: Kevin D McCathy;Roach Brown McCathy & Grber, 1620 Liberty Building, Buffalo, NY, 14202, US

(21) Appl. No.: 10/541,144

(22) PCT Filed: Dec. 8, 2003
(86) PCT No.: PCT/IL03/01033

§ 371 Date: Dec. 20, 2005

(30) Foreign Application Priority Data
Jan. 6, 2003 (IL) 153812

(51) Int. Cl. A01N 25/00

(52) U.S. Cl. 424/405

(57) ABSTRACT

The present invention is an improved wood-plastic composite (WPC) produced from a mixture comprising, wood particles, plastic, and optionally additives. The WPC of the invention further comprises an active ingredient that acts as a biocide. The active ingredient comprises TBBA or a homologue or derivative thereof and is added to the mixture together with the wood particles during and/or before production of the WPC. A method of producing the improved WPC of the invention is described.

### FIELD OF THE INVENTION

The present invention relates to the protection of wood-plastic composites from fungal attack. More particularly, the invention relates to the use of tetrabromobisphenol A and homologues and derivatives thereof in wood-plastic composites as a preservative against microorganism deterioration, particularly fungal attack.

### BACKGROUND OF THE INVENTION

In recent years, the use of wood-plastic composites (WPCs) of many formulations, which have been developed to replace natural wood is increasing at a significant rate annually. The most common types of wood-plastic composites are produced by mixing wood flour and plastics. (It should be noted that the terms “wood flour” and “wood particles” are used interchangeably throughout this specification to designate the wood component of the WPCs.) The resultant material can then be processed like plastics, for example extruded through a die to produce the final product. Many types of plastic are used including, for example, high and low density polyethylene, polypropylene, and PVC. The wood flour is typically made of recycled wood products, scrap wood, and sawdust. Several types of additives are commonly added to the mix, depending on the type of material, production process, and end use of the final product. These additives include: coupling agents, to promote adhesion and dispersion of the particles of the mix; stabilizers, to prevent degradation during processing and service; UV stabilizers, to prevent degradation of the finished product; buffers; foaming agents, to reduce the density of the finished product; and lubricants, to improve flow and prevent edge damage in the extrusion process. Typical examples of formulations, production processes, and production equipment are given in the following U.S. patents: U.S. Pat. No. 6,344,504, U.S. Pat. No. 6,180,257, U.S. Pat. No. 6,117,924, U.S. Pat. No. 5,981,631, and U.S. Pat. No. 5,516,472.

Wood products in use and in storage are prone to deterioration by a variety of micro-organisms but especially fungi such as poria placenta and moulds. It is therefore common to use chemical preservative treatments to prevent such biological deterioration. There are many different wood preservatives known in the art. The main biocide used today in the WPC market is Zinc Borate. Another preservative is Copper Chrome Arsenate. However, these preservative types display disadvantages such as relatively high leaching rates (zinc borate) and high heavy metal contents (CCA).

Articles produced from wood-plastic composites are less susceptible to biological attack than natural wood products because of the plastic which coats the wood particles. However at the edges of the article, wood particles can be exposed to the surroundings and therefore the need for protection against attack does exist. It is not enough for the protection to be provided only on the surface of the article but it should also be provided for all of the wood particles in the wood-plastic composite material since any part of the item can become an outer surface during use when, for example a board is cut to its desired length with a saw. Since the composites are typically composed of approximately 50% each of wood particles and plastic, half of every exposed surface is susceptible to biological attack.

Tetrabromobisphenol A (hereinafter referred to as “TBBA”) has been used, as described in JP 61-6769 (Publication No. 55-159915, dated Dec. 12, 1980), to paint and coat a single plate of wood for the prevention of mould growth. Although the antifungal activity of TBBA has been known for at least 20 years it has not yet found practical application in industry.

TBBA is a well known and efficient fire retardant for organic materials such as wood and plastic compounds. In cases in which fire retardancy is also an important property of the final product, other fire retardants and/or smoke suppressants may be added to the organic systems. Among these may be mentioned, by way of example, halogenated or non-halogenated organo-phosphorus compounds, oxides, sulfides or organic salts of antimony, boron, molybdenum, bismuth or arsenic, zinc borate, magnesium oxide and hydroxide, aluminium trihydrate, as well as other haloorganics, such as decabromodiphenylether, chlorinated polyethylene and chlorinated PVC.

It is therefore an object of this invention to provide wood-plastic composite materials that are resistant to biological wood deterioration.

It is yet another purpose of the invention to provide a method and compositions that do not require the use of harmful solvents.

It is a further object of this invention to provide biocidal compositions based on TBBA, its homologues and derivatives that can be used to preserve wood-plastic composite materials in the absence of the disadvantages inherent in other preserving compounds.

It is a still further purpose of this invention to provide a method for the preservation of wood-plastic composite materials against fungal attack that employs the impregnation and/or mixing and/or coating and/or binding of the wood particles of the composite material with TBBA or its homologues and derivatives.

Further purposes and advantages of this invention will appear as the description proceeds.

### SUMMARY OF THE INVENTION

The present invention employs a biocidal composition comprising as its active ingredient Tetrabromobisphenol A (TBBA ) [CAS RN=79-94-7] or a homologue or a derivative thereof. TBBA is the tetrabrominated form of Bisphenol A of formula

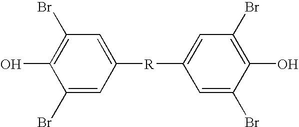

Where, for TBBA, R is C(CH₃)₂.

By “homologues” of TBBA it is meant to indicate those compounds in which the Bisphenol A bridge is replaced by a different moiety. Illustrative and non-limitative examples of such homologues include:
Tetrabromobisphenol F (TBBF), Bis(4-hydroxy-3,5-dibromophenyl)methane [CAS RN=21825-03-6], R is CH₂;
Tetrabromobisphenol Z (TBBZ), 4,4′-Cyclohexylidenebis(2,6-dibromophenol), [CAS RN=53350-96-2], R is 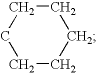
Tetrabromobisphenol E (TBBE), 4,4′-Ethylidenebis(2,6-dibromophenol), [CAS RN=126369-25-3], R is CHCH₃; and
Tetrabromobisphenol S (TBBS), 4,4′-Sulfonyldi(2,6-dibromophenol), [CAS RN=39635-79-5], R is SO₂.

By “derivatives” of TBBA it is meant to indicate those compounds that are further substituted by a substituent other than bromine, either on one or both phenyl rings, or at the bridge. Any such substitutions that do not substantially alter the wood-preserving activity of the resulting compound with respect to TBBA are also encompassed by the present invention.

Preferably, the compound employed is TBBA in a solid state, such as powder or particles, or that has been solubilized in an organic or aqueous solvent. According to a preferred embodiment of the invention, the active compound is provided in aqueous solution. According to another preferred embodiment of the invention, the active compound is dissolved in an organic solvent such as alcohols, e.g. ethanol, hydrocarbons, toluene and ketones. According to still another preferred embodiment of the invention, the active compound is incorporated in an emulsion.

A biocidal wood preservative comprising TBBA as the active ingredient in aqueous solution can be solubilized, for instance, by the addition of TBBA to a solution comprising water, sodium hydroxide (NaOH), and sodium dithionite (Na₂S₂O₄). The concentration of TBBA in the final WPC may be in the range of 0.5% (W/W)-20% (W/W). More preferably, the concentration of TBBA may be in the range of 1% (W/W)-2.5% (W/W).

The long-term preservation, without mould growth or decay, of wood-plastic composite materials, is achieved by mixing and/or impregnating and/or coating the wood particles with an active ingredient, e.g., TBBA, a derivative or a homologue of TBBA, or a mixture of two or more of the same, in solid form, an aqueous solution, an organic solvent, or in an emulsion before the addition of the other components during the process of the production of the WPC.

The method for applying the active ingredient to the wood particles comprises either impregnating the particles by pressure-treatment or, spraying the particles with, or soaking them in such a composition containing TBBA or its homologues and derivatives. After coating or impregnating the wood particles with the aqueous solution, they can be dried, either at ambient or at an elevated temperature, and stored for later use. Another method is to apply the active ingredient to the wood particles, by mixing the dry particles with the solid active material.

### DETAILED DESCRIPTION OF PREFERRED EMBODIMENTS

The aforementioned characteristics and advantages of the invention will be better understood through the following illustrative and non-limitative example of preferred embodiments thereof, which is provided merely to illustrate the invention and is not intended to limit the scope of the invention in any manner.

Manufacturing of the Wood Plastic Composites

The wood-plastic composite is comprised of a polypropylene (pp) homopolymer and wood flour in a weight ratio of about 31-34% pp: 60% wood. A lubricant, such as EBS wax, at a concentration of 6% of the total weight is added to these components.

The wood plastic composites (WPC) were manufactured to the dimensions of 5.375 inches×5.375 inches (136 mm×136 mm) cross-sectional area by 0.75 inches (19 mm) thickness. The equipment utilized for the extrusion process was a Davis-Standard Woodtruder™ WT-94, consisting of a 5 zone 75 mm 24:1 L:D single screw Mark V extruder coupled to a 8 zone 94 mm 28:1 L:D counter-rotating parallel twin screw extruder.

The wood used was Pine wood (American Wood Fiber-40 mesh) and the polypropylene was from British Petroleum pellets. The wood and biocide were introduced into the twin screw where the wood was dried and mixed with the biocide. The polymer was introduced to the wood-biocide mixture in the melt state from the Single Screw Extruder.

Typical Woodtruder™ operating parameters for polypropylene-wood plastic composite production are shown in Table 1.

TABLE 1

| Operating Parameters | Twin Screw (WT-94) | | Single Screw (Mark V) | |
|---|---|---|---|---|
| Temperature Zone 1 | 200 | C. | 245 | C. |
| Temperature Zone 2 | 200 | C. | 232 | C. |
| Temperature Zone 3 | 200 | C. | 225 | C. |
| Temperature Zone 4 | 190 | C. | 210 | C. |
| Temperature Zone 5 | 188 | C. | 200 | C. |
| Temperature Zone 6 | 185 | C. | | |
| Temperature Zone 7 | 163 | C. | | |
| Temperature Zone 8 | 160 | C. | | |
| Temperature Adapter | 167 | C. | | |
| Section | | | | |
| Temperature Clamp | 210 | C. | | |
| Section | | | | |
| Melt Temperature | 154 | C. | | |
| Screw Speed | 29 | rev/min (RPM) | 69 | rev/min (RPM) |
| Motor Load | 85% | | 80% | |
| Pressure (@ Adapter | 700 | lbs/in² (psi) | 1100 | lbs/in² (psi) |
| Vacuum | 26 | in Hg | | |

WPC Product Parameters

| | | |
|---|---|---|
| WPC Linear Rate | 2.7 | ft/min (FPM) |
| WPC Weight Rate | 300 | lbs/hr (PPH) |

In table 2 is shown the composition of five sample types that were produced.

TABLE 2
Mixing Percentages of Components in Test Groups

| | | | Zinc | | |
|---|---|---|---|---|---|
| Blend # | Polypropylene | Wood | Borate | TBBA | EBS |
| 1 | 34% | 60% | 0% | 0% | 6% |
| 2 | 32% | 60% | 2% | 0% | 6% |
| 3 | 33% | 60% | 0% | 1% | 6% |
| 4 | 32.2% | 60% | 0% | 1.8% | 6% |
| 5 | 31.5% | 60% | 0% | 2.5% | 6% |

The 2% zinc borate was used as a positive control, since this compound is presently used as a biocide for WPC.

Mechanical Testing

Samples from the five WPC blends were tested in accordance to ASTM D 638 Tensile testing. Dog bone coupons were cut out (five replicates per blend), and tested using a 22 kip servo-hydraulic Instron universal testing machine (AEWC #108). Measurements were done with a digital caliper (AEWC #249) and Instron extensometer (AEWC #218).

The averaged results of the tensile strength (maximum stress of material) and the stiffness (Tangential [Young's] modulus of elasticity) are shown in table 3. The Coefficient Of Variance (COV) is also indicated for each group.

TABLE 3
Tensile Testing Results (ASTM D 638)

| | Max Stress (psi)¹ | | | Tan MOE (psi) | | |
|---|---|---|---|---|---|---|
| | | | Statis- | | | Statis- |
| | | | tically | | | tically |
| | | | Differ- | | | Differ- |
| Group # | AVG² | COV³ | ent? | AVG | COV | ent? |
| #1, | 2,244.7 | 5.3% | | 592,349 | 25.3% | |
| control | | | | | | |
| #2, 2% | 2,018.3 | 10.1% | N | 622,008 | 17.1% | N |
| zinc borate | | | | | | |
| #3, | 2,015.9 | 9.4% | N | 548,361 | 11.3% | N |
| 1% TBBA | | | | | | |
| #4, | 1,950.0 | 9.5% | N | 543,244 | 13.0% | N |
| 1.8% TBBA | | | | | | |
| #5, | 1,784.7 | 7.8% | Y | 465,821 | 7.9% | N |
| 2.5% TBBA | | | | | | |

Notes:
¹Max Stress (psi) represents the maximum load of the material divided by the cross-sectional area
²AVG represents the mathematical average
³COV represents the coefficient of variance (standard deviation/mean)
⁴Statistically Different. The statistical difference of the groups was done via a One-Way ANOVA calculation using SigmaStatÒ version 2.03 statistical software package. All pair wise multiple comparisons were the Student-Newman-Keuls (SNK) Method.

According to the data in Table 3, there was no statistical difference between the control group and all test groups for stiffness, and the only blend to differ statistically from the control in strength was the 2.5% TBBA blend.

Soil Block Testing

Composite WPC blocks and untreated pine blocks were challenged using a Standard ASTM Soil Block assay (D 1413-76). In this assay, samples are exposed to brown rot and white rot fungi to determine their resistance to decay.

The blocks were exposed to the fungi for 12 weeks as specified in the standard. The fungi used were two brown rot fungi, Gloeophyllum trabeum (ATCC 11539) and Postia placenta (Mad 698R), and two white rot fungi, Trametes versicolor and Irpex lacteus (ATCC 60993).

In addition to the blocks treated with the five WPC blends, a control set of untreated pine blocks was tested at the same time against the same fungi. A sample of the treated WPC blocks was also placed in non-inoculated decay chambers (no fungus present) as reference blocks, and to determine if mass loss/gain could occur in those blocks for reasons unrelated to fungal deterioration. These blocks were used as internal laboratory controls vs. the time zero controls specified in the standard. No charge was made for these blocks. Each set of inoculated blocks consisted of 5 replicate samples tested in separate decay chambers. The weight loss results from the decay testing are shown in table 4.

TABLE 4
Soil Block Assay (ASTM D 1413) of WPC Blends

| | Group | | | | | | | | | |
|---|---|---|---|---|---|---|---|---|---|---|
| | #1, | | #2, | | #3, | | #4, | | #5, | |
| | control | | zinc borate | | 1% TBBA | | 1.8% TBBA | | 2.5% TBBA | |
| Treatment | AWL¹ | (std)² | AWL¹ | (std)² | AWL¹ | (std)² | AWL¹ | (std)² | AWL¹ | (std)² |
| G. trabeum | 1.71 | (0.43) | 0.69 | (0.03) | 0.72 | (0.08) | 0.79 | (0.08) | 0.95 | (0.24) |
| P. placenta | 3.11 | (0.49) | 0.49 | (0.07) | 0.25 | (0.27) | 2.46 | (0.54) | 1.28 | (0.30) |
| T. versicolor | 3.48 | (0.49) | 0.59 | (0.11) | 0.52 | (0.05) | 0.70 | (0.15) | 0.56 | (0.07) |
| I. lacteus | 1.39 | (0.45) | 0.51 | (0.10) | 0.55 | (0.49) | 0.49 | (0.15) | 0.49 | (0.08) |
| Control | 0.16 | | 0.52 | (0.13) | 0.23 | (0.02) | 0.15 | (0) | | |

Notes:
¹AWL: Average Weight Loss (%)
²std: Standard Deviation

The untreated pine controls were aggressively attacked during the test. The brown rot fungi G. trabeum caused approximately 22% weight loss, while the brown rot fungi P. placenta resulted in a 50% weight loss in these reference pine blocks. The white rot fungi T. versicolor caused approximately 14% weight loss, while the white rot fungi I. lacteus incurred a 20% weight loss. White rot fungi are typically less aggressive in soil block tests, as in nature they are more aggressive in hardwood species.

In contrast, although extensive fungal growth was seen on the external surfaces of many of the WPC test blocks, all of the WPC blocks experienced very limited weight loss. The most aggressive attack as indicated by weight loss occurred in the untreated Control WPC samples where the brown rot P. placenta caused approximately 3% weight loss and the white rot T. versicolor caused approximately 3.5% weight loss. This level of weight loss is generally considered to be at the initial stages of ‘incipient’ decay. For all TBBA treatments and the 2% Zn borate samples, weight loss caused by the brown rot G. trabeum, and the white rots T. versicolor and I. lacteus was negligible. The brown rot P. placenta though, caused minor levels of weight loss in the 1.8% TBBA blocks and to a lesser extent in the 2.5% TBBA blocks. Non-inoculated blocks incubated in soil contact showed average weight changes ranging from −0.08% to 0.52%.

In summary, all TBBA formulations performed acceptably, with the 1.0% TBBA WPC material performing very well against all fungi in this test.

Although embodiments of the invention have been described by way of illustration, it will be understood that the invention may be carried out with many variations, modifications, and adaptations, without departing from its spirit or exceeding the scope of the claims. For example, additional conventional additives may be added to the organic system according to the invention. These may comprise other fire retardants, antioxidants (such as Irganox), processing aids, (e.g. lubricants), impact modifiers, UV stabilizers (such as Tinuvins), fillers, fiber reinforcements, smoke suppressors, and pigments.

1. An improved wood-plastic composite (WPC) produced from a mixture comprising, wood particles, plastic, and optionally additives, and further comprising an active ingredient that acts as a biocide, and which comprises tetrabromobisphenol (TBBA) or a homologue or derivative thereof, wherein said active ingredient is added to said mixture together with said wood particles during and/or before production of the WPC.

2. An improved WPC according to claim 1, wherein the active ingredient is added to the mixture together with the wood particles according to one or more methods selected from the group consisting essentially of:
impregnation of said wood particles with said active ingredient;
coating of said wood particles with a solution or emulsion containing said active ingredient;
soaking said wood particles in a solution or emulsion containing said active ingredient; and
mixing said wood particles together with said active ingredient in particulate and/or powder form.

3. An improved WPC according to claim 1, wherein the coating of the wood particles with a solution or emulsion containing the active ingredient is accomplished by spraying said wood particles with said solution or emulsion.

4. An improved WPC according to claim 1, wherein the active ingredient is Tetrabromobisphenol A (TBBA).

5. An improved WPC according to claim 1, wherein the active ingredient is a solid.

6. An improved WPC according to claim 1, wherein the active ingredient is dissolved in a solvent.

7. An improved WPC according to claim 6, wherein the solvent is an aqueous solvent.

8. An improved WPC according to claim 7, wherein the aqueous solvent comprises water, sodium hydroxide (NaOH), and sodium dithionite (Na₂S₂O₄).

9. An improved WPC according to claim 6, wherein the solvent is an organic solvent.

10. An improved WPC according to claim 9, wherein the organic solvent is selected from the group consisting essentially of alcohols, hydrocarbons, toluene and ketones.

11. An improved WPC according to claim 1, wherein the active ingredient is TBBA at a final concentration in said WPC in the range of 0.5% (W/W) to 20% (W/W).

12. An improved WPC according to claim 1, wherein the active ingredient is TBBA at a final concentration in said WPC in the range of 1% (W/W) to 2.5% (W/W).

13. A method of producing an improved wood-plastic composite (WPC) containing TBBA, comprising the steps of:
1. applying TBBA to wood particles by:
a. mixing particles or a powder containing TBBA with the wood particles; or
b. impregnating and/or coating said wood particles with TBBA by means of vacuum impregnation; or
c. soaking said wood particles in a solution or emulsion containing TBBA, or spraying said wood particles with such a solution or emulsion; and
2. combining the wood particles to which TBBA has been applied with the plastic component and optional additives
